(19) United States
(12) Patent Application Publication
(10) Pub. No.: US 2009/0172196 A1
(43) Pub. Date: Jul. 2, 2009

(54) System and Method For Protecting Content Transferred Between Devices

(76) Inventors: Daniel Edward Hogan, Stamford, CT (US); Adam Greenbaum, New York, NY (US)

Correspondence Address: General Electric Company;GE Global Patent Operation, PO Box 861, 2 Corporate Drive, Suite 648, Shelton, CT, 06484, US

(21) Appl. No.: 11/964,762

(22) Filed: Dec. 27, 2007

(51) Int. Cl. G06F 15/16

(52) U.S. Cl. 709/246

(57) ABSTRACT

A method of modifying a series of packets of a content for transmitting to a user over a network includes providing a key that includes at least one aspect of at least one of the packets of a content that is to be modified; and modifying the content based on the key to thereby provide a modified content. A method of rendering a series of packets of a content and a system for modifying a series of packets of a content for rendering by a user are also presented.

### BACKGROUND OF THE INVENTION

1. Field of the Invention

The subject matter described herein relates generally to systems and methods for protecting content and, more particularly, to systems and methods for reducing the value of content when the rendering of it is unauthorized.

2. Related Art

Digital rights management (DRM) is used to categorize a number of techniques for reducing the likelihood of the unauthorized rendering of content. Most of these techniques are very complex and require substantial investment in software and/or hardware to accomplish. For example, methods such as Windows Media DRM, while suitable for progressively downloaded content, does not work well across multiple operating systems, e.g. it does not work well on MacOS/Linux. Also, Windows Media DRM requires a relatively high CPU overhead as it relies on advanced encryption technology to prevent unauthorized use. It is desired to prevent unauthorized downloading of content such as a home made video clips that are readily available from the Internet website http://www.YOUTUBE.com; however, to date, no suitable system or method of protecting content that is transferred from one device to another is available.

### BRIEF DESCRIPTION OF THE INVENTION

In accordance with an embodiment of the present invention, a method of modifying a series of packets of a content for transmitting to a user over a network, comprises providing a key that comprises at least one aspect of at least one of the packets of a content that is to be modified; and modifying the content based on the key to thereby provide a modified content.

In accordance with another aspect of the invention, method of rendering a series of packets of a content comprises receiving a series of packets of a modified content along with a key comprising at least one predetermined location of at least one packet of a predetermined distraction content interleaved with the content in the modified content; and rendering the modified content while modifying or removing the at least one packet of the predetermined distraction content.

In accordance with a further aspect of the invention, a system for modifying a series of packets of a content for rendering by a user at a receiver comprises a first processor for generating a modified content. The first processor may be configured to insert at least one frame of a predetermined distraction content in at least one predetermined location between successive packets in the series of packets of the content according to a key. A second processor may be configured to receive the modified content and to use the key to skip the at least one packet of the predetermined distraction content while rendering the modified content.

### BRIEF DESCRIPTION OF THE DRAWINGS

The following detailed description is made with reference to the accompanying drawings, in which:

FIG. 1 is a diagram showing a system for protecting content in accordance with an embodiment of the present invention;

FIG. 2 is a series of images showing exemplary content that is modified and unmodified in an exemplary embodiment using the system of FIG. 1;

FIG. 3 is another series of images showing exemplary content that is modified and de-modified in another exemplary embodiment using the system of FIG. 1;

FIG. 4 is a flow diagram showing a method for protecting content in accordance with a further aspect of the present invention;

FIG. 5 is a flow diagram showing a method for rendering content in accordance with still a further aspect of the present invention.

### DETAILED DESCRIPTION OF THE PREFERRED EMBODIMENT

One embodiment of the present invention concerns a system and a method for protecting content that is less cumbersome and provides a low cost relative to the prior art. In one particular embodiment, one aspect of a packet of a content that is to be protected is modified based on a key and thereafter may be de-modified using the key and rendered. One advantage to the system and method according to the present invention is that it can be implemented without requiring the user to download additional software, because it can work, e.g., with Flash software from the Adobe corporation of San Jose, Calif.

As used in this disclosure, the term packet may comprise a frame, such as a frame of video content, a page of information such as that transmitted by a system for providing an e-book, and/or a packet of information such as that transmitted over a radio. The term content as used in this disclosure, is intended to refer to video, audio and/or any data transferred. The term rendering as used herein refers to displaying, playing or otherwise outputting a content for use by a user. The term distraction content may refer to a portion of the content and/or additional packets added to the content.

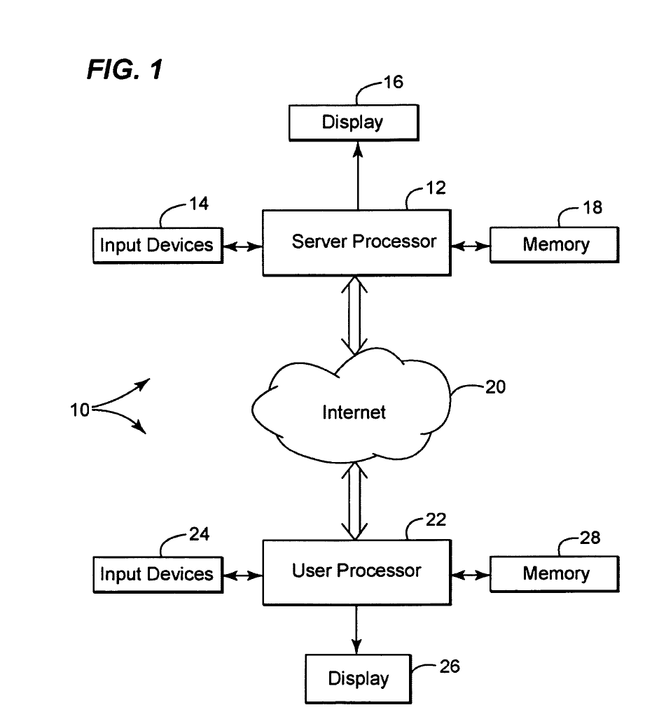

Referring now to FIG. 1, a system for protecting content in accordance with one embodiment of the present invention is illustrated generally at 10. In this embodiment, the system 10 comprises a server processor 12 that may be interconnected between various input devices 14, a display 16, memory 18 and the Internet 20 and a user processor 22 also interconnected between the Internet and various input devices 24, a display 26 and memory 28. It will be understood that the embodiments described herein are not limited to a transfer of content over the Internet, instead, the Internet is intended as one exemplary embodiment of a network over which content may be transferred. It will be appreciated that any network such as a Telco/Mobile network, a local area wireless network, and/or other networks and/or combinations of networks that may or may not also include the Internet may be involved in a transfer of content in accordance with various embodiments of the present invention.

In one exemplary embodiment of the present invention, the server processor 12 may comprise any suitable processor for carrying out a series of steps encoded in software and/or firmware such as a Xeon processor available from the Intel corporation of Santa Clara, Calif. The input devices 14 may comprise, e.g., a keyboard and an optical drive. The display 16 may comprise a flat panel liquid crystal display and the memory 18 may comprise any suitable number of devices for retaining information for use in long term and short term storage by the server processor 12. Examples of memory devices include a hard disk drive, an optical drive, flash memory, and random access memory. In this embodiment, the server processor 12 functions, as described in more detail below, to generate a modified content comprising a series of frames that may be available to download over the Internet 20 by the user processor 22.

The user processor 22, input devices 24, display 26 and memory 28 may each be similar to the input devices 14, the display 16 and the memory 18 described above. The user processor 22 functions as described in more detail below to download, de-modify and display the original content received from the server processor 12.

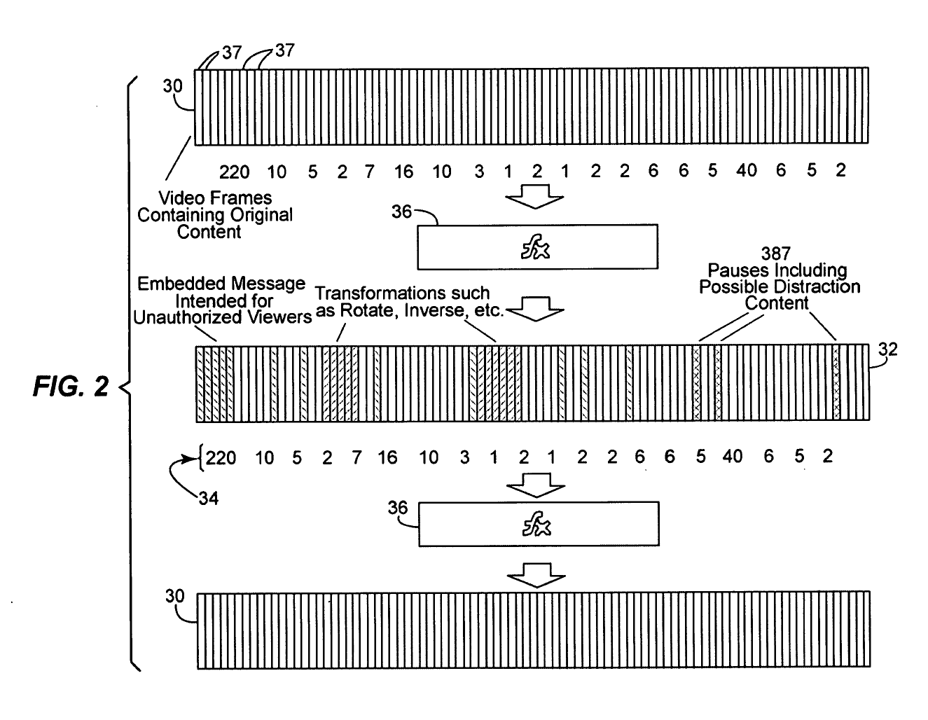

In accordance with an embodiment of the present invention, the server processor 12 is configured, via e.g., software and/or firmware, to modify an aspect of a content such as content 30 shown in FIG. 2 to create a modified content such as modified content 32. In the exemplary embodiment, the content 30 comprises a number of frames 34. As illustrated, a key 34 to a function 36 may comprise a series of numbers that may correspond to, in a first particular embodiment, individual frames 37 to modify or after which to insert an additional frame 38. In this exemplary embodiment, the series of numbers is de-modified by the function 36 as follows: (220) frames of embedded messaging, (10) frames of source content 30, (5) frames of distraction content, (2) frames of source content, (7) frames of distraction content, (16) frames of source content, etc. Accordingly, the function 36, in this exemplary embodiment, may comprise an instruction that the first number in the series of numbers is a number of frames of embedded messaging and, thereafter, every other number in the series of numbers provides a number of frames of source content alternating with a number of frames of distraction content. The instruction may be coded in software or firmware in a known manner and carried out by each of the server processor 12 and the user processor 22. Also, the instruction may be transmitted along with the key as described in more detail below.

It will be understood that the additional frames 38 may be blank, comprise advertising and/or warning messages. In one exemplary embodiment, the modified content 32 may be generated by insertion of the additional frames 38 therein.

The server processor 12 may be further configured, in response to a request from the user processor 22, to forward the modified content 32, in a known manner such as a progressive download over the Internet 20 to a buffer (not shown) interconnected with the user processor 22. Also sent is a copy of the key 34 and, if necessary, a copy of the function 36 (e.g. instructions).

The user processor 22 may be configured to use the key 34 and, where necessary, function 36 to identify one or more locations within the modified content 32 to skip frames in order to properly display the content 30.

It will be appreciated that there may be some difference between the instructions for the function 36 provided to the server processor 12 and those provided to the user processor 22.

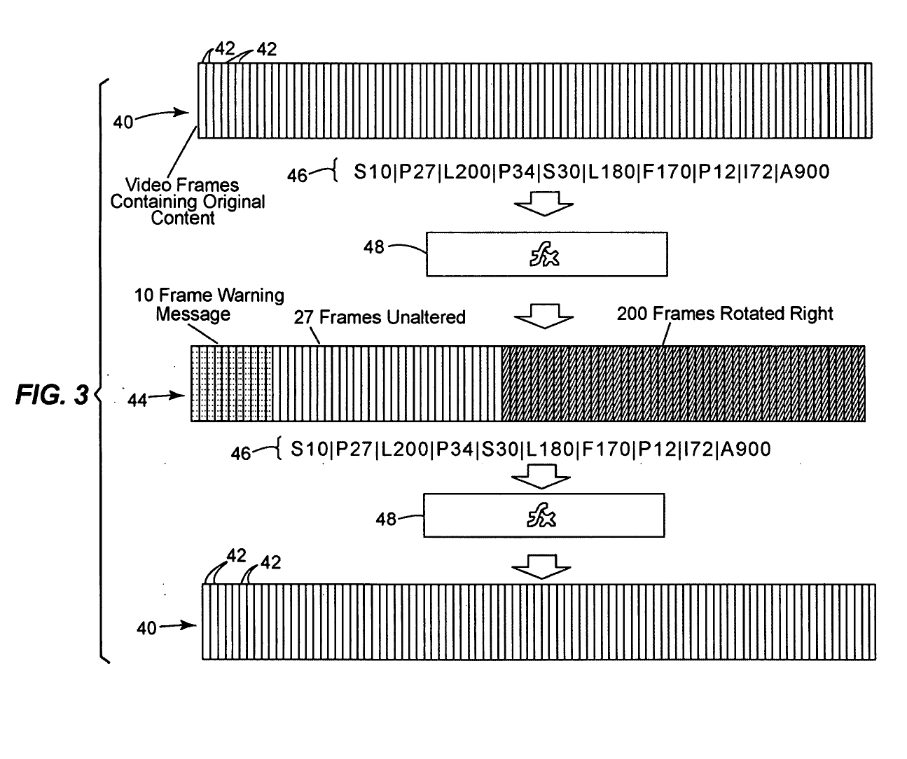

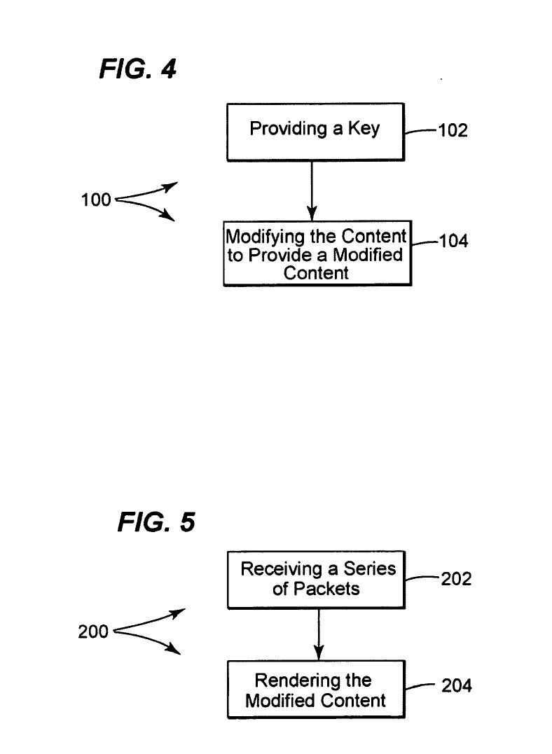

In another exemplary embodiment and referring now to FIG. 3, a content 40 such as video frames 42 may be modified to provide a modified content 44. A key 46 may comprise a series of numbers and letters such as S10|P27|L200|P34|S30|L180|F170|P12|I72|A900 including straight lines as delimiters. To create the modified content 44 in this embodiment, a function 48 may comprise instructions to modify the content 40 based on each letter-number pair that contains a letter code, and a number of frames (n).

Specifically, in this embodiment, the letter code may be as follows: S=skip n frames, P=play n frames of source content unaltered, L=rotate left 90 degrees and play n frames, F=rotate 180 degrees and play n frames, I=inverse all pixels and play n frames and A=display an ad of length n frames. It will be appreciated that such a letter scheme may be chosen for clarity of demonstration. An actual scheme may use non-obvious letters/symbols, and these may be changed with relatively low effort, on a regular basis, to discourage the creation of an unauthorized de-modifier. Also, it will be appreciated that changing the function 48 is relatively simple and de-modifying of the modified content, without knowing the key, is tedious and non-automatable, as opposed to typical encryption or digital rights management (DRM) which attempt to make it so computationally complex as to be impossible with current technology to de-crypt the content.

In another particular embodiment, the key 46 and/or function 48 may be embedded in a watermark using any number of commercially available watermarking technologies such as Verance, and retrieved by a playback component.

In another embodiment, the key may be sent as part of a request separate from the video, a communication that may be secured via any number of known and commercially available encryption techniques, such as known SSL encryption. Optionally, the key may be sent without encryption, since this embodiment does not strictly require the function or the keys to be secret, only tedious to decipher after they have been updated. Encryption would make the function and the keys more difficult to extract and would add to the time required to for an unauthorized use, so for that reason it would be desirable.

The function, or instructions in the example above, used with a key such as S10|P27|L200|P34|S30|L180|F170|P12|I72|A900, may be embedded in a video player code, and updated on a periodic basis.

Other embodiments of the present invention may include, rather than insertion of frames into the content 30, rotation of one or more frames 34, reversing the order of the frames and/or scrambling of the frames. For example, splitting the frame into quadrants (Q1 to Q4) and displaying Q1 content in Q2, Q2 content in Q3, etc. Other examples include inserting annoying noises or tones, shifting the video and wrapping it vertically, so that the top frames and are on the bottom and vice-versa.

In accordance with another aspect of the present invention a method of modifying a series of packets of a content for transmitting to a user over a network is shown generally at 300 in FIG. 3. As shown at 302, the method comprises providing a key comprising at least one aspect of at least one of the packets of the content that is to be modified, and as shown at 304, modifying the content based on the key to thereby provide a modified content. Where the packets comprise frames of video and/or audio, modifying the content 304 may comprise generating at least one frame of a predetermined distraction content; identifying at least one location between successive frames in the series of frames of the content; and inserting the distraction content into the content.

Referring now to FIG. 5, a method of rendering a series of packets of a content is shown generally at 200. The method comprises, as shown at 202, receiving a series of packets of a modified content along with a key comprising at least one predetermined location of at least one packet frame of a predetermined distraction content interleaved with the content in the modified content. As shown at 204, rendering the modified content while modifying and/or removing the at least one packet of the predetermined distraction content.

Technical effects of the herein described systems and methods include providing a modified series of video and/or audio frames that reduces the likelihood of an unauthorized rendering.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

What is claimed is:

1. A method of modifying a series of packets of a content for transmitting to a user over a network, comprising:
providing a key that comprises at least one aspect of at least one of the packets of a content that is to be modified; and
modifying the content based on the key to thereby provide a modified content.

2. The method of claim 1, wherein:
the packets comprise frames of video and/or audio;
modifying the content comprises:
generating at least one frame of a predetermined distraction content;
identifying at least one location between successive frames in the series of frames of the content; and
inserting the distraction content into the content.

3. The method of claim 1, further comprising transmitting the modified content and the key to the user.

4. The method of claim 2, wherein generating at least one frame of a predetermined distraction content comprises inserting a plurality of frames of a predetermined distraction content and the key corresponds with a predetermined function.

5. The method of claim 4, wherein the predetermined function comprises instructions for interpreting the key.

6. The method of claim 2, wherein the first content comprises video frames with audio and the distraction content comprises at least one video frame that is non-sequential to/from that succeeding/preceding the video frames of the predetermined location.

7. The method of claim 2, wherein the first content comprises video frames with audio and the distraction content comprises audio distraction.

8. The method of claim 6, wherein the distraction content comprises at least one of a warning message, at least one advertising frame and at least one blank frame.

9. A method of rendering a series of packets of a content, comprising:
receiving a series of packets of a modified content along with a key comprising at least one predetermined location of at least one packet of a predetermined distraction content interleaved with the content in the modified content; and
rendering the modified content while modifying and/or removing the at least one packet of the predetermined distraction content.

10. A system for modifying a series of packets of a content for rendering by a user, comprising:
a first processor for generating a modified content, the first processor configured to insert at least one frame of a predetermined distraction content in at least one predetermined location between successive packets in the series of packets of the content according to a key; and
a second processor configured to receive the modified content and to use the key to skip the at least one packet of the predetermined distraction content while rendering the modified content.

11. The system of claim 10, wherein the first processor inserts a plurality of frames of a predetermined distraction content and the key corresponds with a predetermined function.

12. The system of claim 11, wherein the predetermined function comprises instructions for interpreting the key.

13. The system of claim 10, wherein the packets comprise video frames with audio and the distraction content comprises at least one video frame that is non-sequential to/from that succeeding/preceding the video frames of the predetermined location.

14. The system of claim 10, wherein the packets comprise video frames with audio and the distraction content comprises audio distraction.

15. The system of claim 13, wherein the distraction content comprises at least one of a warning message, at least one advertising frame and at least one blank frame.
